(19) United States
(12) Patent Application Publication
(10) Pub. No.: US 2025/0379524 A1
(43) Pub. Date: Dec. 11, 2025

(54) DUAL ACTIVE BRIDGE PARAMETER ESTIMATION FOR CONTROL CONFIGURATION

(71) Applicant: Rivian IP Holdings, LLC, Irvine, CA (US)

(72) Inventors: Vishnu Narayan Vipin, Torrance, CA (US); Mohammad Nanda R. Marwali, Irvine, CA (US); Zahra Mohajerani, Los Angeles, CA (US)

(21) Appl. No.: 18/740,115

(22) Filed: Jun. 11, 2024

(51) Int. Cl. H02M 3/335; H02M 1/00

(52) U.S. Cl. CPC H02M 3/33584; H02M 1/0009; H02M 1/0058

(57) ABSTRACT

Systems and methods for operating a dual active bridge (DAB) converter include causing a current to flow through a transformer of the DAB converter, measuring the current, determining, based on the measured current, a leakage inductance of the transformer, and determining, based on the leakage inductance of the transformer, a control scheme for operating the DAB converter. In some embodiments, determining the leakage inductance includes determining a tank resistance of the transformer. In some embodiments, the control scheme includes a gain schedule, a zero-voltage switching scheme, or both, where the control scheme differs from a nominal control scheme, based on a nominal leakage inductance, and improves a power conversion efficiency or an accuracy of an output voltage as compared to the nominal control scheme.

### INTRODUCTION

The present disclosure is directed to systems and methods for determining parameters of a power converter. More specifically, the present disclosure is directed to adjusting a control scheme of a power converter based on a property of the power converter.

### SUMMARY

A dual active bridge (DAB) converter is a type of power electronics equipment that may use a transformer as a part of a DC to DC power conversion. It may be useful to determine the leakage inductance or other electromagnetic properties of the transformer and operate the DAB converter based on this determination.

In some embodiments, control circuitry of a DAB converter may determine the leakage inductance of a transformer of the DAB converter based on measuring current flows through the transformer. In some embodiments, the control circuitry may operate the DAB converter to determine the leakage inductance when there is no load connected to the output of the converter. In other embodiments, the control circuitry may operate the DAB converter to transfer power to a load connected to the output of the converter and simultaneously determine the leakage inductance. Based on the leakage inductance of the transformer, the control circuitry may determine and implement a corresponding control scheme. For example, the control circuitry may determine a particular zero-voltage switching scheme (e.g., to increase efficiency) or a particular gain schedule (e.g., to improve dynamic performance, e.g., in response to a change in the properties of a load) based on the leakage inductance.

In accordance with embodiments of the present disclosure, a method for operating a dual active bridge (DAB) converter includes causing a current to flow through a transformer of the DAB converter, measuring the current, based on the measured current, determining a leakage inductance of the transformer, and based on the leakage inductance of the transformer, determining a control scheme for operating the DAB converter.

In some embodiments, determining the control scheme includes determining a zero-voltage switching scheme for the DAB converter, where the control scheme differs from a nominal control scheme based on a nominal leakage inductance of the transformer, and where the control scheme increases, compared to the nominal control scheme, a power conversion efficiency of the DAB converter when the determined leakage inductance deviates from the nominal leakage inductance.

In some embodiments, determining the control scheme includes scheduling a plurality of gains of the DAB converter based on the determined leakage inductance, where the control scheme differs from a nominal control scheme based on a nominal leakage inductance of the transformer, and where the control scheme increases, compared to the nominal control scheme, accuracies of the plurality of scheduled gains when the determined leakage inductance deviates from the nominal leakage inductance.

In some embodiments, the method also includes applying one of the plurality of gains based on a property of a load that receives power from the DAB converter.

In some embodiments, determining the control scheme includes determining a plurality of control schemes, each one of the plurality of control schemes corresponding to a respective mode of operation of the DAB converter.

In some embodiments, determining the leakage inductance of the transformer includes, based on the measured current, determining a tank resistance of the transformer, and determining the leakage inductance based on the tank resistance.

In some embodiments, the measured current includes a first measured waveform and a second measured waveform, where the first measured waveform is used to determine the tank resistance, and the second measured waveform is used to determine the leakage inductance.

In some embodiments, causing the current to flow through the transformer of the DAB converter includes controlling a first leg of a bridge of the DAB converter based on a first triangular carrier waveform and a first DC modulation signal, controlling a second leg of the bridge of the DAB converter based on a second triangular carrier waveform and a second DC modulation signal, and configuring a phase shift between the first triangular carrier waveform and the second triangular carrier waveform such that an amplitude of the current through the transformer is within a predetermined current range. In some embodiments, the predetermined current range is based on a saturation current range of the transformer (e.g., to avoid saturating the transformer).

In some embodiments, the method also includes configuring the first DC modulation signal and the second DC modulation signal such that a deadtime of the first leg and a deadtime of the second leg are within a predetermined range. In some embodiments, the predetermined range is based on achieving ZVS conditions. In other embodiments (e.g., operating outside of ZVS conditions, e.g., to determine the leakage inductance), the predetermined range is based on achieving a desired loss across one or more switches.

In some embodiments, causing the current to flow through the transformer of the DAB converter includes controlling a first leg of a bridge of the DAB converter based on a first triangular carrier waveform and a first sinusoidal modulation signal, controlling a second leg of the bridge of the DAB converter based on a second triangular carrier waveform and a second sinusoidal modulation signal, and configuring a frequency of the first triangular current waveform and a frequency of the second triangular current waveform such that a frequency of the current through the transformer is within a predetermined range. In some embodiments, the predetermined range is based on a sampling rate of control circuitry, a saturation current range of the transformer, or a combination thereof.

In some embodiments, the method also includes configuring the first sinusoidal modulation signal and the second sinusoidal modulation signal such that an amplitude of the current through the transformer is within a predetermined range. In some embodiments, the predetermined range is based on a saturation current range of the transformer.

In some embodiments, the method also includes configuring a phase shift between the first triangular current waveform and the second triangular current waveform such that an amplitude of the current through the transformer is within a predetermined current range when toggling switches of the first leg and switches of the second leg. In some embodiments, the predetermined range is based on achieving ZVS in the switches to eliminate the effect of deadtime on the bridge voltages.

In some embodiments, the method includes configuring a secondary side bridge of the DAB converter such that, while causing the current to flow through the transformer of the DAB converter, a voltage across the secondary side bridge is equal to zero.

In some embodiments, measuring the current includes low-pass filtering the current and determining a root mean square value of the filtered current.

In some embodiments, determining the leakage inductance of the transformer includes applying an expression that relates a measured input power of the DAB converter to a measured output power of the DAB converter when the current flows through the transformer of the DAB converter.

In accordance with embodiments of the present disclosure, a dual active bridge (DAB) converter includes processing circuitry configured to cause a current to flow through a transformer of the DAB converter, measure the current, based on the measured current, determine a leakage inductance of the transformer, and based on the leakage inductance of the transformer, determine a control scheme for operating the DAB converter. In some embodiments, compared to a control scheme based on a nominal leakage inductance, the control scheme based on the leakage inductance provides improved dynamic performance (e.g., reduced overshoots and undershoots of the dynamic power output that occurs in response to changes in a load connected to the DAB converter) (e.g., wider stability margins, or a stricter adherence to operating within constant stability margins).

In some embodiments, the processing circuitry is configured to determine the control scheme for operating the DAB converter by determining a zero-voltage switching scheme for the DAB converter, where the control scheme differs from a nominal control scheme based on a nominal leakage inductance of the transformer, and increases, compared to the nominal control scheme, a power conversion efficiency of the DAB converter when the determined leakage inductance deviates from the nominal leakage inductance.

In some embodiments, the processing circuitry is configured to determine the control scheme for operating the DAB converter by scheduling a plurality of gains of the DAB converter based on the determined leakage inductance, where the control scheme differs from a nominal control scheme based on a nominal leakage inductance of the transformer, and increases, compared to the nominal control scheme, accuracies of the plurality of scheduled gains when the determined leakage inductance deviates from the nominal leakage inductance. In some embodiments, the improved dynamic performance is based on the increased accuracies of the plurality of scheduled gains.

In some embodiments, the processing circuitry is configured to determine the leakage inductance of the transformer by, based on the measured current, determining a tank resistance of the transformer, and determining the leakage inductance based on the tank resistance.

In accordance with embodiments of the present disclosure, a non-transitory computer-readable medium has non-transitory computer-readable instructions encoded thereon that, when executed by a processor, cause the processor to cause a current to flow through a transformer of a dual active bridge (DAB) converter, measure the current, based on the measured current, determine a leakage inductance of the transformer, and based on the leakage inductance of the transformer, determine a control scheme for operating the DAB converter.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 shows an illustrative block diagram of an electric vehicle charging system including power electronics equipment for providing power to a load and/or an energy storage system, in accordance with some embodiments of the present disclosure;

FIG. 2 is an illustrative block diagram showing additional details of some components of power electronics equipment, in accordance with some embodiments of the present disclosure;

FIG. 3 is an illustrative circuit schematic of a first dual active bridge (DAB) converter, in accordance with some embodiments of the present disclosure;

FIG. 4 is an illustrative depiction of currents through the transformer of a DAB converter, in accordance with some embodiments of the present disclosure;

FIG. 5 is an illustrative depiction of signals during a first mode of operation for determining the leakage inductance of the transformer of a DAB converter, in accordance with some embodiments of the present disclosure;

FIG. 6 is an illustrative depiction of signals during a second mode of operation for determining the leakage inductance of the transformer of a DAB converter, in accordance with some embodiments of the present disclosure;

FIG. 7 is an illustrative signal processing flowchart for determining the leakage inductance of the transformer of a DAB converter, in accordance with some embodiments of the present disclosure;

FIG. 8 is an illustrative flowchart of a first method for determining the leakage inductance of a DAB converter, in accordance with some embodiments of the present disclosure;

FIG. 9 is an illustrative circuit schematic of a second dual active bridge (DAB) converter, in accordance with some embodiments of the present disclosure;

FIG. 10 is an illustrative flowchart of a second method for determining the leakage inductance of a DAB converter, in accordance with some embodiments of the present disclosure;

FIG. 11 is an illustrative depiction of signals for determining the leakage inductance of the transformer of a DAB converter during a power conversion operation, in accordance with some embodiments of the present disclosure; and

FIG. 12 is an illustrative flowchart of a method for determining a control scheme for operating a DAB converter based on a determined leakage inductance, in accordance with some embodiments of the present disclosure.

### DETAILED DESCRIPTION

The performance of power supply systems can vary based on the dynamic properties of electric or electromagnetic components of the system. Real-time (or nearly real-time) determination of these dynamic properties may be implemented to modify operating procedures of a power supply system (e.g., systems providing tightly controlled output voltages to dynamic loads) and meet constraints around output voltage or output power specifications.

Many power supply systems (e.g., DC-DC power converters, including DAB converters) include a transformer having a leakage inductance and other electromagnetic properties. It can be challenging to dynamically operate a power converter based on a leakage inductance of the transformer, at least because the leakage inductance varies from device to device, varies over time in response to use in the field, and depends on the properties (which may also vary over time) of components coupled (directly or indirectly) to the transformer.

Potential inaccuracy in characterizing a transformer's leakage inductance can reduce the performance (e.g., the efficiency of power conversion, the ability to compensate for transient load properties, any other suitable performance feature, or any combination thereof) of a DAB converter (or any other suitable power converter that includes a transformer). Provided herein are systems and methods for determining the leakage inductance of a transformer and operating a DAB converter based on the determined leakage inductance. In some embodiments, the systems and methods are configured for automated (e.g., occurring without manual intervention, e.g., on a schedule, in response to one or more predetermined conditions, or in response to a local or remote command) and/or rapid (e.g., occurring within less than 1 minute or less than 1 second) determination of the leakage inductance. In some embodiments, the leakage inductance is determined during a normal power conversion operation of the DAB converter.

Based on the determined leakage inductance, control circuitry modifies the operation of the DAB converter. For example, the control circuitry may retrieve a gain schedule (e.g., a protocol for setting a range of controller parameters for a range of possible operating regions) from memory of the DAB converter based on the leakage inductance. For another example, the control circuitry may otherwise or additionally retrieve a zero-voltage switching scheme (e.g., a switch timing protocol for reducing switching losses during power conversion) from memory of the DAB converter based on the leakage inductance. In some embodiments, the modified operation of the DAB converter is based on adjusting a nominal operating scheme, corresponding to a nominal leakage inductance (e.g., that is measured on commissioning of the DAB converter, or is estimated based on empirical data and/or physical models), to a modified scheme corresponding to the determined leakage inductance (or corresponding to a deviation between the nominal and determined leakage inductances).

Accordingly, as described above and as further described in detail below, methods and corresponding systems and computer-readable media are provided for determining the leakage inductance of a transformer of a DAB converter and for modifying an operation of the DAB converter based on the determined leakage inductance.

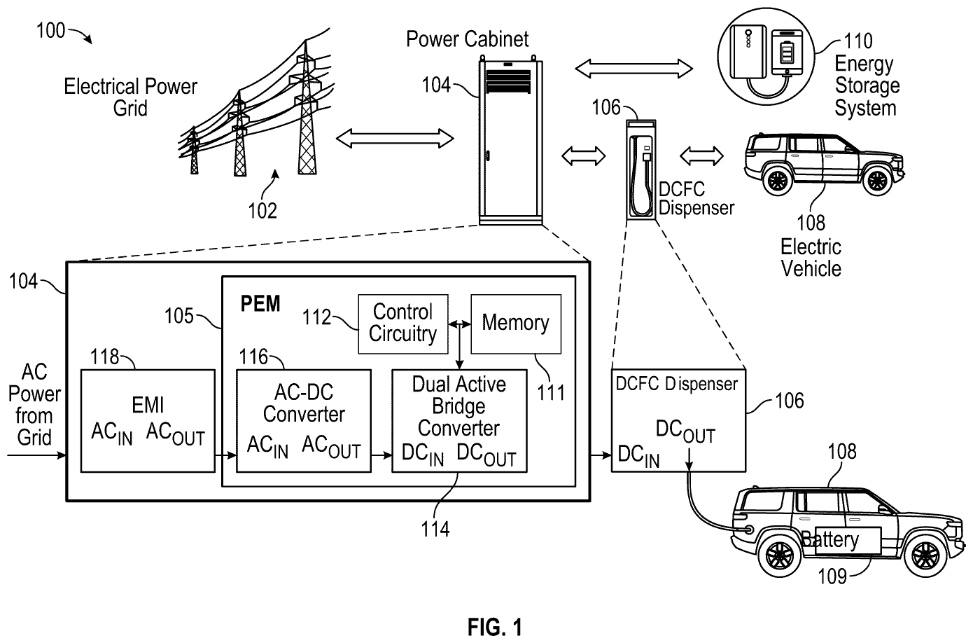

FIG. 1 depicts an illustrative block diagram 100 of an electric vehicle charging system including a DAB converter for providing power to a load and/or an ESS, in accordance with some embodiments of the present disclosure. Power is input to the system by electrical power grid 102, which is coupled to power cabinet 104. Power cabinet 104 is coupled to direct current fast charge (DCFC) dispenser 106. Through a direct connection or through dispenser 106, power cabinet 104 ultimately delivers power to at least one of electric vehicle 108 (specifically battery 109 therein) and/or energy storage system (ESS) 110. Power cabinet 104 includes one or more power electronics module (PEM) 105, each of which includes DAB converter 114 as well as memory 111 and control circuitry 112, where memory 111 may include instructions for operating control circuitry 112 to control DAB converter 114 according to the operations described above and as further described below. In some embodiments, DAB converter 114 is electrically isolated from other components of block diagram 100 and is configured for bidirectional flow (e.g., DAB converter 114 can either send power to or receive power from DCFC dispenser 106 or ESS 110). Embodiments of the present disclosure may serve either direction of power flow through DAB converter 114. Additionally included in PEM 105 is AC to DC converter 116, which may convert incoming AC power from the electric grid to a first DC power that can then be converted into a second DC power (e.g., by DAB converter 114) for powering connected loads. In some embodiments, AC to DC converter 116 may convert incoming DC power (e.g., from electric vehicle 108 or ESS 110, through DAB converter 114) to AC power that may be supplied to the electric grid (e.g., to provide grid support) or AC loads (e.g., to provide backup power, grid islanding, supplemental power, any other suitable source of AC power, or any combination thereof).

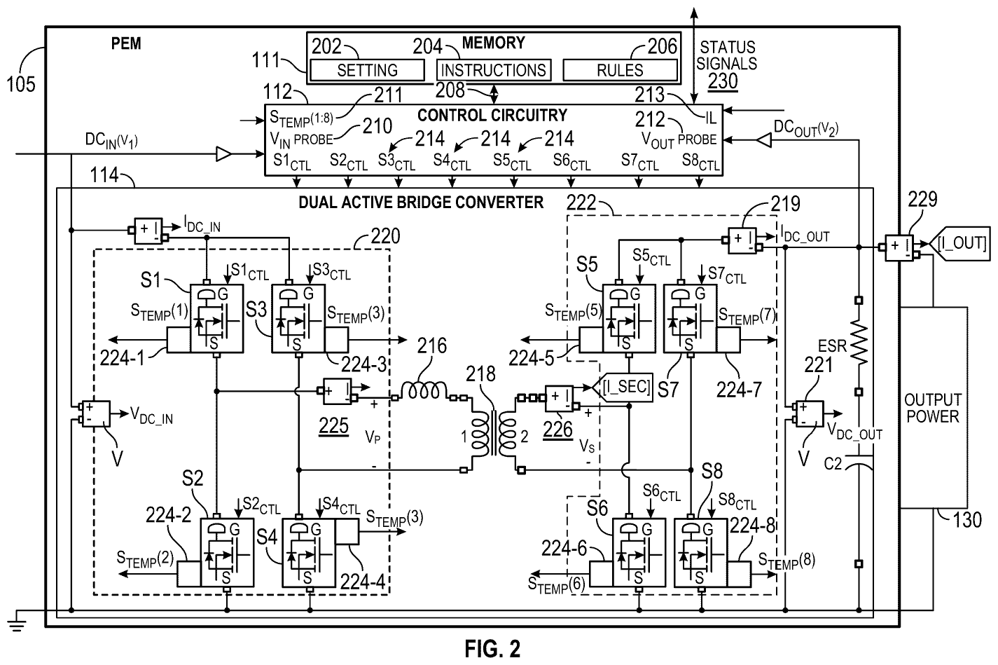

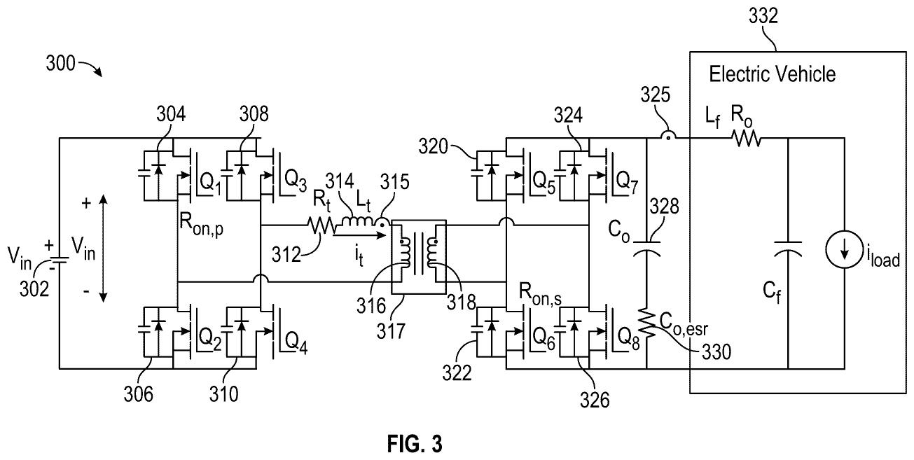

FIG. 2 is an illustrative block diagram showing additional details of some components of power electronics equipment, in accordance with some embodiments of the present disclosure. Memory 111 may be an electronic storage device. As referred to herein, the phrase “electronic storage device” or “storage device” may refer to any device for storing electronic data, computer software, or firmware, such as random-access memory, read-only memory, solid state devices, or any other suitable fixed or removable storage devices, and/or any combination thereof. Memory 111 may be used to store various types of instructions, rules, and/or other types of data. For example, memory 111 may include instructions for how to determine the leakage inductance of a transformer (e.g., transformer 218). In some embodiments, the instructions of memory 111 may include one or more ways to operate the DAB converter 114 such that control circuitry 112 can determine the leakage inductance of the transformer 218 (e.g., in connection with the subject matter of FIGS. 3-11). Furthermore, memory 111 may include rules (e.g., reference values used for calculating a leakage inductance, waveforms to apply across a transformer, reference equations for determining a leakage inductance based on measured properties, signal processing techniques for determining a leakage inductance from measured properties, specific properties to measure to determine a leakage inductance, constraints on various operating parameters including saturation currents and sampling rates, or any combination thereof) for determining the leakage inductance of a transformer. In some embodiments, control circuitry 112 executes instructions related to an application stored in memory 111 (e.g., to apply one or more waveforms, measurements, and/or signal processing schemes to determine the leakage inductance of the transformer of DAB converter 114). Specifically, control circuitry 112 may be instructed by the application to perform the functions discussed herein, including sending control signals to toggle individual switches and/or legs of switches. In some embodiments, any action performed by control circuitry 112 may be based on instructions received from the application. In some embodiments, the application may be implemented as software or a set of executable instructions that may be stored in memory 111 and executed by control circuitry 112.

Memory 111 may store settings 202, instructions 204, and rules 206. Example types of settings 202 may include PEM output settings, DAB control settings (e.g., DAB switch toggling settings), DAB switching schemes (e.g., for measuring the health of the transformer), duty cycle settings (e.g., for maintaining switches of the DAB converter below a threshold temperature limit), delay settings (e.g., as may be associated with states of the DAB converter), other types of settings, or any combination thereof. In some embodiments, the settings 202 may be configured to vary based on a measured or determined leakage inductance. For example, settings 202 or rules 206 may include details for how to modify a nominal operating procedure (e.g., including gain scheduling and zero-voltage switching schemes) of DAB converter 114 to account for a deviation between a nominal leakage inductance and a measured leakage inductance.

Example types of rules 206 include mappings for applying DAB control settings based on a measured leakage inductance, PEM output settings, computational constants (e.g., any one or more electromagnetic properties of the inductors, transformers, switches, transistors, capacitors, or other electronics of DAB converter 114), overvoltage conditions, overcurrent conditions, negative current conditions, switching sequences, DAB models, DAB controls, snubber capacitances, other possible transient load dynamics, other types of information or data, or any combination thereof. In some embodiments, instructions 204 are executed by control circuitry 112 to implement steps of various methods described herein (e.g., based on applicable settings 202 and/or rules 206). In some embodiments, control circuitry 112 uses data stored in memory 111 to execute operations described in connection with FIGS. 3-11.

DAB converter 114 includes transformer 218 (which has a leakage inductance that may be measured and/or determined (e.g., calculated) by control circuitry 112) including a primary bridge winding and a secondary bridge winding, primary side bridge 220, and secondary side bridge 222. Primary side bridge 220 is coupled to a primary side of transformer 218 through inductor 216, which may be a physical winding, a leakage inductance of the transformer 218, or a combination thereof. Secondary side bridge 222 is coupled to a secondary side of transformer 218. As used herein, the “primary side” or “primary bridge” of a DAB converter (e.g., DAB converter 114) may refer to the portion of a DAB converter appearing to the left of a transformer (e.g., transformer 218), and the “secondary side” or “secondary bridge” of DAB converter 114 may refer to the portion of a DAB converter appearing to the right of a transformer. It is noted that the “primary” and “secondary” designations of the sides or bridges of the DAB converter are based on the assumption that an input power is provided to the left side of transformer 218, and an output power is provided from the right side of transformer 218. In some embodiments, an input power may be provided to the right side of transformer 218 (e.g., by electric vehicle 108, energy storage system 110, or electric vehicle 332) and an output power may be provided from the left side of transformer 218 (e.g., to electrical power grid 102 or a load connected in place of Vin 302), in which case the right side of transformer 218 may be the “primary side” and the left side of transformer 218 may be the “secondary side”. As used herein, Vp and Vs refer to the voltage on the primary side of transformer 218 and the voltage on the secondary side of transformer 218, respectively. DAB converter 114 also includes primary side switches S1, S2, S3, and S4 located on the primary side of DAB converter 114 and secondary side switches S5, S6, S7, and S8 located on the secondary side of DAB converter 114. As used herein, a “leg” of a DAB converter bridge refers to a pair of switches that are coupled in series (e.g., switches S1 and S2, S3 and S4, S5 and S6, or S7 and S8). Switches S1, S2, S3, S4, S5, S6, S7, and S8 may be any suitable type of electronic switch, such as a field effect transistor (FET)-based switch, that can be enabled (e.g., switched on/closed, during which current is permitted to be conducted between its source and drain terminal) or disabled (e.g., switched off/open, during which current is effectively prevented from being conducted between its source and drain terminal) by changing a logic level of the control signal provided to its gate terminal, for example from a logic-high to a logic-low.

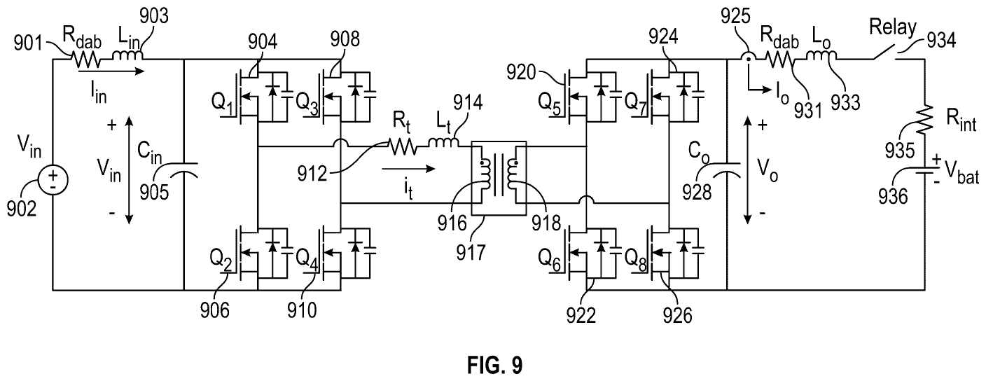

In some embodiments, legs of DAB converter 114 may be toggled (e.g., periodically opened and closed) in response to control signals from control circuitry 112, where such signals may correspond to a desired power output of PEM 105 or a desired scheme for determining a leakage inductance of the transformer 218. These signals may include particular temporal delays to configure how one or more current waveforms conduct across the transformer, to control power output, to achieve other desirable control effects, or any combination thereof. In some embodiments, switches S1-S8 may be wide bandgap (WBG) based power semiconductors, such gallium nitride (GaN) or silicon carbide (SiC) based semiconductors. In some embodiments, switches S1-S8 may include other types of metal-oxide-semiconductor field-effect transistors (MOSFETs). As shown, each of the switches S1-S8 includes an anti-parallel diode. As described in connection with at least FIGS. 3 and 9, switches Q1-Q8 may respectively correspond to switches S1-S8 as shown in FIG. 2, including switches Q1-Q8 having the same connections as switches S1-S8 to control circuity 112, temperature sensors 224, and other aspects of PEM 105.

In some embodiments, temperature sensors 224-1, 224-2, 224-3, 224-4, 224-5, 224-6, 224-7, and 224-8 (collectively referred to as temperature sensors 224), are coupled to and configured to measure the temperatures of switches S1, S2, S3, S4, S5, S6, S7, and S8, respectively. Temperature sensors 224-1, 224-2, 224-3, 224-4, 224-5, 224-6, 224-7, and 224-8, output to control circuitry 112 signals (S_{TEMP}(1) through S_{TEMP}(8), collectively, S_{TEMP}(1:8)) indicating sensed temperatures of switches S1 through S8, respectively. In some embodiments, data from one or more temperature sensors 224-1, 224-2, 224-3, 224-4, 224-5, 224-6, 224-7, and 224-8 may be indicative of voltage levels and/or temperature changes occurring across switches S1-S8. Complete signal paths from output ports S_{TEMP}(1) through S_{TEMP}(8) of temperature sensors 224-1, 224-2, 224-3, 224-4, 224-5, 224-6, 224-7, and 224-8 to temperature input port 211 (S_{TEMP}(1:8)) of control circuitry 112 are omitted from FIG. 2 for clarity. Nonetheless, output ports S_{TEMP}(1) through S_{TEMP}(8) of temperature sensors 224-1, 224-2, 224-3, 224-4, 224-5, 224-6, 224-7, and 224-8 are indeed coupled to temperature input port 211 (S_{TEMP}(1:8)) of control circuitry 112 through a signal bus or other suitable respective signal paths. In some embodiments, one or more of temperature sensors 224 may be omitted. For example, in some embodiments, only a single temperature sensor may be provided for each leg or for each side of DAB converter 114. In some embodiments, temperature signals can be used as feedback information for the control circuitry 112 to determine whether a control scheme of DAB converter 114 (e.g., based on a measured leakage inductance) satisfies output requirements, and the control scheme may be modified based on feedback signals indicating that certain output requirements are not satisfied.

In some embodiments, current sensor 229 is configured to sense output current (i_OUT) of PEM 105 and output to control circuitry 112 a signal indicating the output current as is delivered to output power 130. A signal from current sensor 229 may be used to determine a control scheme of DAB converter 114 (e.g., how to switch the switches or toggle the legs therein). For example, current sensor 229 may indicate an output power 130 of PEM 105, where the output power may be associated with a particular switching scheme of DAB converter 114. Similarly, current sensor 219 is configured to sense an output current (IDC_OUT). Current sensor 219 may be configured the same as current sensor 229, including to be used by control circuitry 112 to determine a switching scheme of DAB converter 114. In some embodiments, current sensor 229 may correspond to current sensor 925. In some embodiments, voltage sensor 221 may be coupled in parallel to current sensor 219 to measure an output voltage (VDC_OUT) of PEM 105, and a signal from voltage sensor 221 may also be used to determine a leakage inductance of transformer 218 of DAB converter 114.

In some embodiments, current sensor 226 is configured to sense the current across the secondary side of transformer 218 and to output to control circuitry 112 a signal indicating the secondary side transformer current. In some embodiments, a signal from current sensor 226 (with or without the signal from current sensor 219) may be used to determine a leakage inductance of the transformer 218 or a corresponding control scheme of the DAB converter 114. In some embodiments, a voltage sensor may be coupled in parallel to current sensor 226 or in another suitable location to measure a transformer voltage. In some embodiments, with or without the signal from voltage sensor 221, such a voltage sensor may be used to determine a leakage inductance of the transformer 218 or a corresponding control scheme of the DAB converter 114.

In some embodiments, current sensor 225 is configured to sense the current across the primary side of transformer 218 and output to control circuitry 112 a signal indicating the primary current. In some embodiments, a signal from current sensor 225 (with or without the signal from current sensor 219) may be used to determine a leakage inductance of the transformer 218 or a corresponding control scheme of the DAB converter 114. In some embodiments, a voltage sensor may be coupled in parallel to current sensor 225 or in another suitable location and may be used to determine a leakage inductance of the transformer 218 or a corresponding control scheme of the DAB converter 114. In some embodiments, voltage sensor 221 or any other voltage or current sensor may be used to determine a leakage inductance of the transformer 218 or a corresponding control scheme of the DAB converter 114. In some embodiments, current sensor 225 may correspond to current sensor 315.

Control circuitry 112 includes memory interface port 208, first input port 210 (V_{IN Probe}), temperature input port 211, second input port 212 (V_{OUT Probe}), current input port 213, and multiple output ports 214. Control circuitry 112 is configured to transmit and receive instructions, settings, rules, and/or other types of data to and from memory 111 via memory interface port 208. For example, control circuitry 112 may be configured to implement particular control schemes or switch toggling schemes (e.g., for measuring signals indicative of a property of the transformer 218, or for delivering a specific output voltage profile from the DAB converter 114 based on the property of the transformer 218) based on instructions from memory 111. Control circuitry 112 is configured to sense a temperature of one or more of switches S1-S8. Control circuitry 112 is configured to sense a secondary-side output voltage (e.g., V_{OUT Probe}) via input port 212. In some embodiments, the voltage from voltage input port 212 is measured to determine a leakage inductance of transformer 218. In some embodiments, the instructions 208 provided to control circuitry 112 are based on a desired scheme for determining the leakage inductance of transformer 218, for determining one or more voltage signals recorded in DAB converter 114, for monitoring one or more temperature sensors of DAB converter 114, system status indicators, any other suitable information, or any combination thereof.

Output ports 214 include primary switching control ports S1_{CTL}, S2_{CTL}, S3_{CTL}, and S4_{CTL}, by which control circuitry 112 provides respective switch control signals to respective switching control ports S1_{CTL}, S2_{CTL}, S3_{CTL}, and S4_{CTL} of primary side switches S1, S2, S3, and S4. Output ports 214 also include secondary switching control ports S5_{CTL}, S6_{CTL}, S7_{CTL}, and S8_{CTL}, by which control circuitry 112 provides respective switch control signals to respective switching control ports S5_{CTL}, S6_{CTL}, S7_{CTL}, and S8_{CTL} of secondary side switches S5, S6, S7, and S8, respectively. Complete signal paths from switching control ports S1_{CTL}, S2_{CTL}, S3_{CTL}, S4_{CTL}, S5_{CTL}, S6_{CTL}, S7_{CTL}, and S8_{CTL} of control circuitry 112 to S1_{CTL}, S2_{CTL}, S3_{CTL}, S4_{CTL}, S5_{CTL}, S6_{CTL}, S7_{CTL}, and S8_{CTL} of DAB 114 are omitted from FIG. 2 for clarity. Nonetheless, switching control ports S1_{CTL}, S2_{CTL}, S3_{CTL}, S4_{CTL}, S5_{CTL}, S6_{CTL}, S7_{CTL}, and S8_{CTL} of control circuitry 112 are indeed coupled to SI_{CTL}, S2_{CTL}, S3_{CTL}, S4_{CTL}, S5_{CTL}, S6_{CTL}, S7_{CTL}, and S8_{CTL} of DAB 114 via respective signal paths. In some embodiments, control circuitry 112 is configured to cause switch toggling based on sending control signals (e.g., switch control signals S1_{CTL}, S2_{CTL}, S3_{CTL}, S4_{CTL} of primary side bridge 220, and/or switch control signals S5_{CTL}, S6_{CTL}, S7_{CTL}, and S8_{CTL} of secondary side bridge 222) that are provided according to a switching sequence to cause a current to flow through transformer 218 (e.g., to determine a leakage inductance of the transformer, to provide output power to a load, or both). In some embodiments, control circuitry 112 is configured to cause switch toggling to occur based on sending control signals (e.g., including to maintain switches in the open state) that are provided according to one or more modified power operation modes (e.g., where the modified mode of DAB converter operation corresponds to the leakage inductance of transformer 218).

The output of DAB converter 114 is coupled to a load that is configured to receive output power 130. For example, either of electric vehicle 108 or ESS 110 may be charged using output power 130. In response to dynamic power requirements of output power 130, control circuitry 112 may adjust control or switching schemes of DAB converter 114 (e.g., the schemes being gain-scheduling and/or zero-voltage switching schemes) to deliver particular levels of dynamic power. For example, DAB converter 114 may provide more power (e.g., faster charging) when the state-of-charge of electric vehicle 108 or ESS 110 is low (e.g., less than 5%, 10%, 20%, or any other suitable low state-of-charge) and DAB may provide less power (e.g., slower charging) when the state-of-charge of electric vehicle 108 or ESS 110 is high (e.g., greater than 80%, 90%, 95%, or any other suitable high state-of-charge).

In some embodiments, types of switches and/or switch configurations that differ from those shown in FIG. 2 may be utilized (e.g., switches with source and drain terminals located in positions that are the opposite of those shown in FIG. 2, active-high switches that are enabled with a logic-high gate voltage, active-low switches that are enabled with a logic-low gate voltage, or the like). The particular switches and configurations and logic levels shown and described herein are provided as illustrative examples. The principles herein apply similarly to other types of switches and/or switch configurations. The switches relating to the examples described herein are active-high switches that are closed (e.g., turned on) with a logic-high gate voltage and are open (e.g., turned off) with a logic-low gate voltage.

In some embodiments, control circuitry 112 is configured to send status signals 230 (e.g., indicating the leakage inductance of the transformer 218). For example, control circuitry 112 may send a command to communication circuitry (e.g., of PEM 105) and one or more recipients of the status signal 230, the command indicating a leakage inductance of the transformer 218.

Although a PEM 105 is illustrated and described, it should be understood that DAB converter 114 may be used for any power system that includes handling of direct current (DC) as an input, output, or intermediate power, such as to charge electric vehicle 108 or ESS 110.

FIG. 3 is an illustrative depiction 300 of a dual active bridge (DAB) converter, in accordance with some embodiments of the present disclosure. In some embodiments, depiction 300 captures the elements used to determine a leakage inductance of transformer 317. In some embodiments, elements 304, 306, 308, 310, 320, 322, 324, and 326 may correspond to elements S1, S2, S3, S4, S5, S6, S7, and S8 (of FIG. 2), respectively. In some embodiments, windings 316 and 318 may correspond to the primary bridge winding of transformer 218 and the secondary bridge winding of transformer 218, respectively. In some embodiments, V_{IN} 302 may correspond to DC_{IN} power provided to DAB 114. In some embodiments, electric vehicle load 332 may correspond to battery 109, ESS 110, or a combination thereof. In some embodiments, leakage inductance 314 may correspond to inductance 216, leakage resistance 312 may correspond to a resistance of the winding 316 (and/or a circuit path that is coupled to at least the top side of winding 316), current sensor 315 may correspond to current sensor 225, current sensor 325 may correspond to current sensor 219, and capacitance 328 and resistance 330 may correspond to elements ESR and C2 (of FIG. 2), respectively. As shown, R_{on,p} may refer to the resistance of a primary-side current path, including one or more switches and wires coupled to the one or more switches, when current is flowing from source 302 to primary winding 316; R_{on,s} may refer to the resistance of a secondary-side current path, including one or more switches and wires coupled to the one or more switches, when current is flowing from secondary winding 318 to electric vehicle load 332.

A DAB converter (e.g., DAB converter 114) may transfer DC power from source 302 to electric vehicle load 332. In some embodiments, any one or more of primary side switches 304, 306, 308, or 310 may be controlled (e.g., by control circuitry 112) to cause particular current waveforms to flow across primary winding 316. The control circuitry 112 may determine leakage inductance 314 based on the measured current waveforms. While leakage inductance 314 is shown as a discrete element, it is noted that this inductance may not represent a winding-based inductor, but rather it may represent a non-zero leakage inductance of the transformer and/or other elements of the circuit. The leakage inductance 314 may thus be based on one or more properties of the transformer 317. In addition, a leakage inductance may be attributed to non-zero inductances of wires, capacitors, transformers, other discrete electronic devices, lumped circuit components, or any combination thereof.

In some embodiments, when measuring and/or determining the leakage inductance 314, control circuitry 112 may cause secondary-side switches 322 and 326 to remain in an ON or closed position (e.g., to short together the two terminals of secondary side bridge 318, to short these terminals to ground, and/or to cause a voltage across the secondary side bridge 318 to be equal to zero) and may cause secondary-side switches 320 and 324 to remain in an OFF or open position (e.g., to isolate a load 332 from the transformer 317).

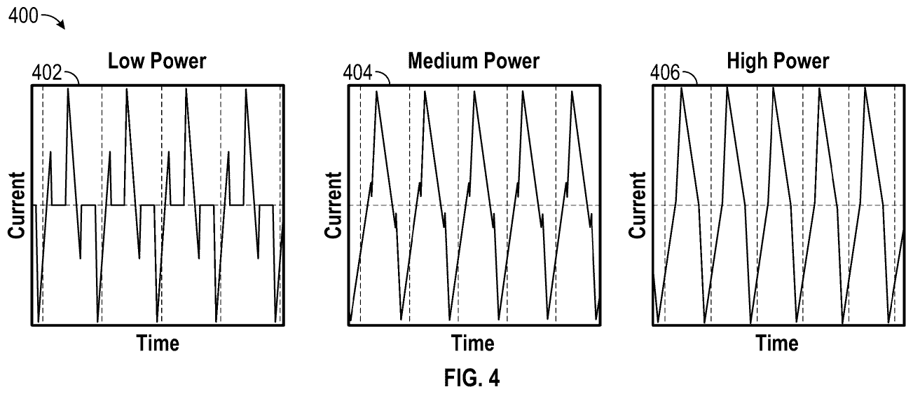

FIG. 4 is an illustrative depiction of currents through the transformer of a DAB converter, in accordance with some embodiments of the present disclosure. As shown, discrete current profiles (e.g., time-dependent current signals, which are associated with a duty cycle and/or a particular waveform) can be driven through the DAB converter (e.g., DAB converter 114, 300, or 900) based on a particular mode of operation. Current profiles 402, 404, and 406 are respectively illustrative of current waveforms that may occur during low power (e.g., less than 30% of a maximum output power), medium power (e.g., between 30-70% of a maximum output power), and high power (e.g., greater than 70% of a maximum output power) operations. It is noted that these current profiles and these modes of operation may depend on the leakage inductance of the transformer.

In some embodiments, the current profiles 402, 404, and 406 may differ from each other due to gain schedules and/or zero-voltage switching schemes of DAB converter 114, which can depend on a desired output power or other transient property (e.g., impedance or state-of-charge) of a load that is connected to DAB converter 114. In some embodiments, memory 111 includes a plurality of gain schedules and/or zero-voltage switching schemes that are based on a leakage inductance or that may be derived (e.g., based on a deviation between the measured leakage inductance and a nominal leakage inductance) from a measured leakage inductance.

As used herein, gain scheduling may refer to a timing scheme for toggling the switches of the DAB converter to deliver a desired power output. In some embodiments, control circuitry 112 may, compared to a control scheme based on a nominal transformer leakage inductance, improve the accuracy of gain scheduling of a DAB converter by implementing a modified control scheme based on the determined leakage inductance. Therefore, DAB converter 114 can deliver power to a load with improved dynamic output voltage profiles in response to transient changes in the power delivered to the load, while maintaining a target level of power conversion efficiency. Control circuitry 112 may incorporate instructions of memory 111 to deliver accurate gain scheduling across a range of target operating regions (e.g., based on one or more input voltage levels and a range of possible output voltage levels) and possible leakage inductance values.

As used herein, zero-voltage switching (ZVS) scheduling may refer to a timing scheme for toggling the switches of the DAB converter when there is zero (or nearly zero) voltage across the switches. ZVS operation may improve a power conversion efficiency of a DAB converter because less energy is lost during switch toggling. ZVS operation may similarly improve the thermal management of a DAB converter because there is less energy loss that is dissipated as heat. In some embodiments, control circuitry 112 may, compared to a ZVS scheme based on a nominal transformer leakage inductance, improve the accuracy of a ZVS scheme based on the leakage inductance by implementing a modified control scheme based on the determined leakage inductance. Therefore, DAB converter 114 can deliver power to a load with less power loss and heating of equipment. Control circuitry 112 may incorporate instructions of memory 111 to deliver accurate ZVS schemes across a range of target output power conditions and possible leakage inductance values.

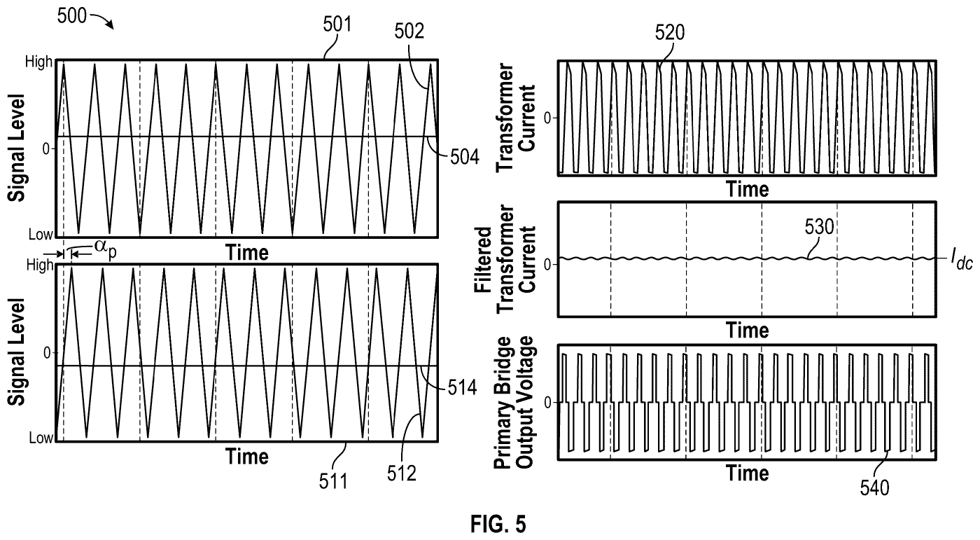

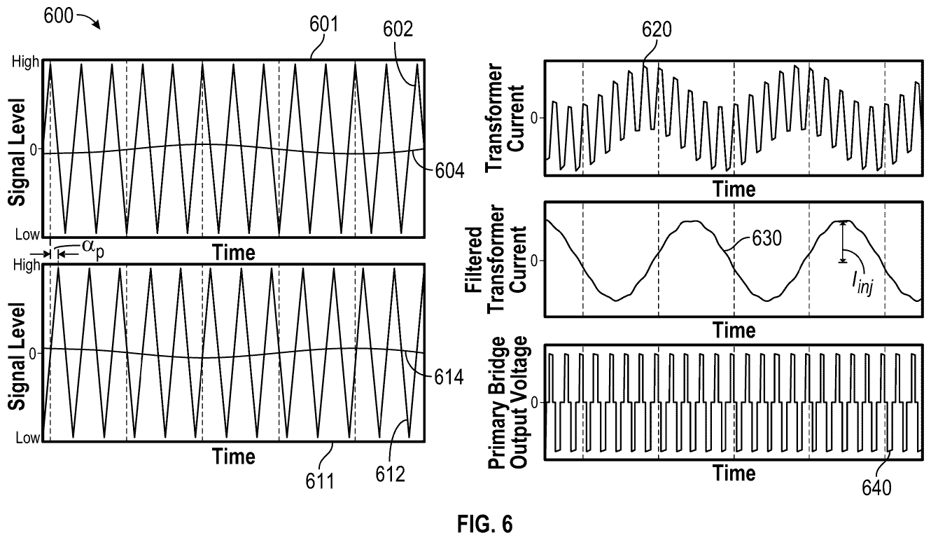

It is noted that in FIG. 4 and elsewhere (e.g., including FIGS. 5-6), all waveforms are merely illustrative of particular operating conditions. Control circuitry 112 may cause similar waveforms to flow through any part of a DAB converter without departing from the scope of the present disclosure. For example, these waveforms may be modified to have one or more parameters (e.g., a frequency, amplitude, deadtime, or other suitable parameter) that is within a predetermined range. For another example, these waveforms may be modified based on a leakage inductance of the transformer (e.g., where the leakage inductance may be determined according to the methods and systems described herein).

FIG. 5 is an illustrative depiction of DAB converter signals during a first mode of operation for determining the leakage inductance of the transformer of a DAB converter (e.g., DAB converter 300), in accordance with some embodiments of the present disclosure. In some embodiments, control circuitry 112 controls a first leg (e.g., switches 304 and 306) of a bridge (e.g., the primary bridge) of a DAB converter based on a first triangular carrier waveform 502 and a first DC modulation signal 504. As used herein, a modulation signal may refer to a signal that is used as a reference against which another signal is compared, for the sake of determining a state of a switch, as further described below. In some embodiments, control circuitry 112 controls a second leg (e.g., switches 308 and 310) of the bridge of the DAB converter based on a second triangular carrier waveform 512 and a second DC modulation signal 514. In some embodiments, control circuitry 112 implements switch toggling based at least in part on DC modulation signals 504 and 514 to drive a current (e.g., filtered transformer current 530) with a specific DC magnitude (e.g., I_{dc}) through the transformer (e.g., where I_{dc} is an average value of filtered transformer current 530, as shown in FIG. 5). As shown between waveforms 502 and 512, the control circuitry 112 may configure a specific phase shift (e.g., αₚ) between these two waveforms, such that switches are toggled according to the specific phase shift and an amplitude of the current through the transformer (e.g., transformer current 520 or filtered transformer current 530) is within a predetermined current range when toggling switches of the first leg and switches of the second leg. In some embodiments, the control circuitry 112 configures modulation signals 504 and 514 such that a deadtime (e.g., the period during which no switch is on) of the first leg and a deadtime of the second leg are within a predetermined time range.

In some embodiments, control circuitry 112 causes the switches of the first leg and the switches of the second leg to toggle according to the following scheme. The top switch of the first leg (e.g., switch 304) may be turned ON or closed when the level of the first DC modulation signal 504 exceeds that of the first triangular carrier waveform 502. The top switch of the first leg may otherwise be turned OFF or opened. The top switch of the second leg (e.g., switch 306) may be turned ON or closed when the level of the second DC modulation signal 514 exceeds that of the second triangular carrier waveform 502. The top switch of the second leg may otherwise be turned OFF or opened. Control circuitry 112 maintains the bottom switch of the first leg (e.g., switch 306) and the bottom switch of the second leg (e.g., switch 310) in positions that are complementary (e.g., when one is ON, the other is OFF) to the top switch of the first leg and the top switch of the second leg, respectively.

In response to the control circuitry 112 controlling the legs of the primary side of the DAB converter based on waveforms 502, 504, 512, and 514, current 520 flows through the transformer (e.g., transformer 218 or 317). Control circuitry 112 may apply a filter (e.g., a low-pass filter) to current 520 to record filtered transformer current 530. In some embodiments, the filtered transformer current is a DC signal with a magnitude that is used by control circuitry 112 to estimate the transformer resistance 312 (e.g., in connection with at least some of the equations (1)-(21) and (A1)-(A2), as described below). In some embodiments, applying voltage waveform 540 across a bridge (e.g., primary bridge 316) of a DAB converter causes transformer current 520 to flow through the transformer of the DAB converter.

In some embodiments, filtered transformer current 530 (and/or any of the other waveforms shown in FIG. 5) may represent a first waveform. The first waveform may correspond to a first control scheme that is used for measuring the leakage inductance of a DAB converter. The first waveform and the first control scheme may be used to determine the tank resistance (e.g., as represented by transformer resistance 312) of the transformer. In some embodiments, the tank resistance is applied (e.g., in connection with at least some of the equations (1)-(21) and (A1)-(A2), as described below) in a subsequent process for determining the leakage inductance of the transformer.

FIG. 6 is an illustrative depiction of DAB converter signals during a second mode of operation (e.g., corresponding to a second waveform) for determining the leakage inductance of the transformer of a DAB converter, in accordance with some embodiments of the present disclosure. In some embodiments, control circuitry 112 controls a first leg (e.g., switches 304 and 306) of a bridge (e.g., the primary bridge) of a DAB converter based on a first triangular carrier waveform 602 and a first sinusoidal modulation signal 604. In some embodiments, control circuitry 112 controls a second leg (e.g., switches 308 and 310) of the bridge of the DAB converter based on a second triangular carrier waveform 612 and a second sinusoidal modulation signal 614. The control circuitry 112 may configure a frequency of the first triangular carrier waveform 602 and a frequency of the second triangular carrier waveform 604 such that a frequency of the current through the transformer (e.g., transformer current 620 or filtered transformer current 630) is within a predetermined range (e.g., below a Nyquist sampling rate). Control circuitry 112 may configure the first sinusoidal modulation signal 604 and the second sinusoidal modulation signal 614 such that an amplitude of the current through the transformer (e.g., transformer current 620 or filtered transformer current 630) is within a predetermined range (e.g., below a saturation current limit, while still being measurable with a suitable signal-to-noise ratio (SNR)). As shown, control circuitry 112 may configure a phase shift (e.g., αₚ) between the first triangular current waveform 602 and the second triangular current waveform 612 such that an amplitude of the current through the transformer (e.g., transformer current 620 or filtered transformer current 630) is within a predetermined current range when toggling switches of the first leg and switches of the second leg. In some embodiments, control circuitry 112 implements switch toggling based at least in part on sinusoidal modulating signals 604 and 614 to drive a current (e.g., filtered transformer current 630) with a specific frequency (e.g., fᵢₙⱼ) and a specific AC amplitude (e.g., Iᵢₙⱼ) through the transformer (e.g., where Iᵢₙⱼ is a peak amplitude (e.g., measured with respect to an average or zero value of the current) of filtered transformer current 630, as shown in FIG. 6).

In some embodiments, control circuitry 112 causes the switches of the first leg and the switches of the second leg to toggle according to the following scheme. The top switch of the first leg (e.g., switch 304) may be turned ON or closed when the level of the first sinusoidal modulation signal 604 exceeds that of the first triangular carrier waveform 602. The top switch of the first leg may otherwise be turned OFF or opened. The top switch of the second leg (e.g., switch 306) may be turned ON or closed when the level of the second sinusoidal modulation signal 614 exceeds that of the second triangular carrier waveform 612. The top switch of the second leg may otherwise be turned OFF or opened. Control circuitry 112 maintains the bottom switch of the first leg (e.g., switch 306) and the bottom switch of the second leg (e.g., switch 310) in positions that are complementary (e.g., when one is ON, the other is OFF) to the top switch of the first leg and the top switch of the second leg, respectively.

In response to the control circuitry 112 controlling the legs of the primary side of the DAB converter based on waveforms 602, 604, 612, and 614, current 620 flows through the transformer (e.g., transformer 218 or 317). Control circuitry 112 may apply a filter (e.g., a low-pass filter) to current 620 to record filtered transformer current 630. In some embodiments, the filtered transformer current is an AC signal with a magnitude that is used by control circuitry 112 to estimate the transformer leakage inductance 314 (e.g., in connection with at least some of the equations (1)-(21) and (A1)-(A2), as described below). In some embodiments, applying voltage waveform 640 across a bridge (e.g., the primary bridge 316) of a DAB converter causes transformer current 620 to flow through the transformer of the DAB converter.

In some embodiments, filtered transformer current 630 (and/or any of the other waveforms shown in FIG. 6) may represent a second waveform (e.g., with reference to the first waveform being one of those shown in FIG. 5). The second waveform may correspond to a second control scheme that is used for measuring the leakage inductance of a DAB converter. The second waveform and the second control scheme may be used to determine the leakage inductance of the transformer (e.g., based at least on the tank resistance, e.g., as determined using the first waveform and the first control scheme).

In some embodiments, the control scheme for determining the leakage inductance (e.g., a second mode) is applied by control circuitry 112 after the control scheme for determining the tank resistance (e.g., a first mode). As such, triangular carrier waveforms 602 and 612 may respectively be third and fourth triangular carrier waveforms (with reference to triangular carrier waveforms 502 and 512 being the first and second triangular carrier waveforms). For example, control circuitry 112 may drive the first and second waveforms of FIG. 5 in connection with determining a transformer link resistance (e.g., in connection with operations 821 and 831, or the first mode), and control circuitry 112 may then drive the third and fourth waveforms of FIG. 6 in connection with determining a transformer inductance (e.g., in connection with operations 822 and 832, or the second mode).

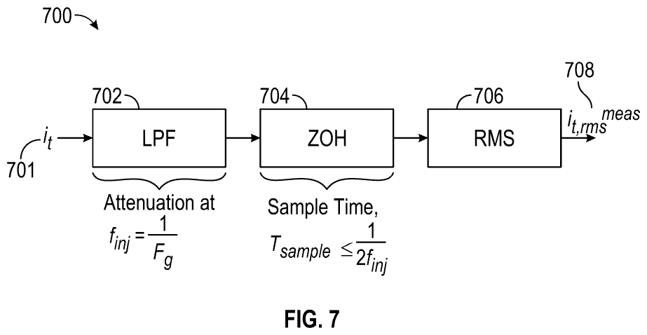

FIG. 7 is an illustrative signal processing flowchart for determining the leakage inductance of the transformer of a DAB converter, in accordance with some embodiments of the present disclosure. In some embodiments, control circuitry 112 of the DAB converter is configured to process a measured current iₜ 701 as shown through the signal processing flow 700.

At 702, control circuitry 112 configures the DAB converter to couple the measured current iₜ 701 to low-pass filter (LPF) (e.g., a digital or analog low-pass filter). In some embodiments, the LPF 702 attenuates a magnitude of measured current it 701 based on an attenuation factor F_{g} (which, e.g., may be a frequency-dependent attenuation that is applied, in calculations made by control circuitry 112, based on the frequency fᵢₙⱼ). In some embodiments, the LPF at 702 modifies transformer current 520 into filtered transformer current 530, or the LPF at 702 modifies transformer current 620 into filtered transformer current 630.

At 704, control circuitry 112 couples the output of LPF 702 to zero-order hold (ZOH) 704. In some embodiments, ZOH 704 includes sampling the signal with a digital-to-analog (DAC) converter. In some embodiments, the DAC converter samples the signal with a timing interval less than the reciprocal of 2*fᵢₙⱼ (e.g., the signal is sampled at a frequency higher than the Nyquist frequency).

At 706, control circuitry 112 couples the output of ZOH 704 to a root-mean-square (RMS) 706 calculator. In some embodiments, RMS 706 provides a measured RMS current i_{t,rms}^{meas} 708. The measured RMS current i_{t,rms}^{meas} 708 may be used by control circuitry 112 to determine or calculate the tank resistance, e.g., using the equation:

$${R}_{est} = 2 ( {m}_{dc} - {T}_{d} {f}_{sw} ) \frac{{V}_{in}}{{i}_{t , rms}^{meas}} \qquad ( A1 )$$

where Rₑₛₜ is the tank resistance, m_{dc} is the length of the duty cycle of the bridge voltage waveform (e.g., voltage waveform 540) applied during the resistance estimation mode 821, T_{d} is the deadtime of a switch being controlled, f_{sw} is the switching frequency of the bridge switches (e.g., as per being controlled by control circuitry 112 based on a triangular carrier wave and a corresponding modulation signal), Vᵢₙ is the input voltage (e.g., source voltage 302), and i_{t,rms}^{meas} is as described above. In some embodiments, the control circuitry 112 induces a nonzero deadtime in one or more switches of the DAB converter as part of determining Rₑₛₜ. For example, this deadtime may reduce the effective duty cycle of the bridge voltage based on the non-ZVS operation and the corresponding nonzero DC component of the transformer current.

In some embodiments, control circuitry 112 may determine the leakage inductance based on the tank resistance using the following equation:

$${L}_{est} = \frac{1}{{ω}_{inj}} \sqrt{\frac{{( {mV}_{in} )}^{2}}{2 {( {i}_{t , rms}^{meas} {F}_{g} )}^{2}} - {R}_{est}^{2}} \qquad ( A2 )$$

where Lₑₛₜ is the leakage inductance, ωᵢₙⱼ is 2*π*fᵢₙⱼ, and the other terms of equation A2 are as described above.

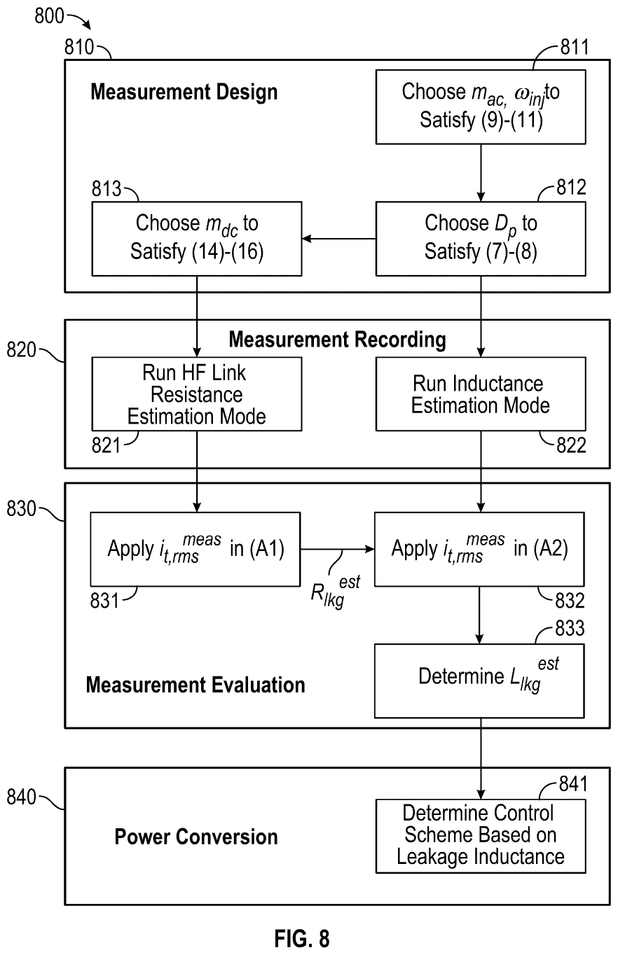

FIG. 8 is an illustrative flowchart of a first method for determining the leakage inductance of a DAB converter (e.g., DAB converter 114 or 300), in accordance with some embodiments of the present disclosure. It is noted that this method may provide greater than 99% accuracy in determining the leakage inductance of a DAB converter across a wide range of possible variances associated with the leakage inductance and the tank resistance. In some embodiments, this accuracy is maintained across a wide tolerance range (e.g., at or exceeding 20%) with respect to the accuracy of values that are used for determining the leakage inductance and with respect to values that are associated with various parameters of the DAB converter 114 (or values that are associated with elements thereof).

In some embodiments, equations (1)-(20), as listed below, are used (e.g., with equations (A1) and (A2), as listed above) by control circuitry (e.g., control circuitry 112, e.g., when executing the method of FIG. 8) to determine the leakage inductance of a transformer of a DAB converter:

$${T}_{sw} = \frac{1}{{f}_{sw}} \qquad ( 1 )$$

$${D}_{p} = 1 - \frac{{α}_{p}}{π} \qquad ( 2 )$$

$${I}_{hf} ≅ \frac{1}{2} \frac{{V}_{in}}{{L}_{nom}} {D}_{p} \frac{{T}_{sw}}{2} \qquad ( 3 )$$

$${I}_{soft} = {I}_{hf} - {I}_{inj} \qquad ( 4 )$$

$${I}_{inj} = \frac{{m}_{ac} {V}_{in}}{{ω}_{inj} {L}_{nom}} \qquad ( 5 )$$

$${I}_{max 2} = {I}_{hf} + {I}_{inj} \qquad ( 6 )$$

$${I}_{max 2} < 0.9 {I}_{sat} \qquad ( 7 )$$

$${I}_{soft} \geq {I}_{ZVS} \qquad ( 8 )$$

$${T}_{sample} \leq \frac{1}{2 {f}_{inj}} \qquad ( 9 )$$

$${I}_{inj} > 20 {I}_{sense , min} \qquad ( 10 )$$

$${m}_{res} > {m}_{pwm , min} , {m}_{ac} = ( \# of quantized steps in a sinusoid ) * {m}_{res} \qquad ( 11 )$$

$${I}_{dc} = \frac{2 ( {m}_{dc} - {T}_{d} {f}_{sw} ) {V}_{in}}{{R}_{dc}} \qquad ( 12 )$$

$${I}_{dc} + {I}_{hf} = {I}_{max 1} \qquad ( 13 )$$

$${m}_{dc} > {T}_{d} {f}_{sw} \qquad ( 14 )$$

$${I}_{dc} > {I}_{sense , min} \qquad ( 15 )$$

$${I}_{max 1} < 0.9 {I}_{sat} \qquad ( 16 )$$

$${i}_{t} = {V}_{in} * \frac{{m}_{ac}}{j {ω}_{inj} {L}_{est} + {R}_{est}} \qquad ( 17 )$$

$${i}_{t , rms} = \frac{{m}_{ac} {V}_{in}}{\sqrt{{( {ω}_{inj} {L}_{est} )}^{2} + {R}_{est}^{2}}} \frac{1}{\sqrt{2}} \qquad ( 18 )$$

$$\frac{{( {m}_{ac} {V}_{in} )}^{2}}{2 {i}_{t , rms}^{2}} = {ω}_{inj}^{2} {L}_{est}^{2} + {R}_{est}^{2} \qquad ( 19 )$$

$${i}_{t , rms} = {i}_{t , rms}^{meas} {F}_{g} \qquad ( 20 )$$

where Iᵢₙⱼ is the amplitude of the injected AC current (e.g., transformer current 630 scaled by a factor of the low-pass filter attenuation gain at fᵢₙⱼ) during the leakage inductance estimation mode, I_{hf} is the peak value of the transformer current (e.g., transformer current 520 or 620) with no low frequency injection, Dₚ is the primary bridge voltage duty cycle, I_{ZVS} is the minimum current required for ZVS (or soft switching, e.g., switching near ZVS conditions) operation of the bridge switches, Iₛₐₜ is a saturation current of the transformer (e.g., transformer 218 or 317), I_{sense,min} is a minimum current resolution of the transformer current sensor (e.g., current sensor 315), Lₙₒₘ is a nominal leakage inductance of a transformer, m_{ac} is the peak amplitude (e.g., measured with respect to an average or zero value) of the bridge voltage waveform (e.g., voltage waveform 640) applied during the inductance estimation mode 822,, m_{pwm,min} is the minimum duty cycle than can be implemented on a microprocessor based on the PWM clock frequency specifications, I_{soft} is the minimum current that may be available for discharging the FET capacitances under the combined effect of injected AC currents and the carrier frequency currents and the other terms of equations (1)-(20) are as described above (e.g., in connection with equations (A1) or (A2), and/or FIG. 7). In the leakage inductance estimation mode, equation (8) may be applied (e.g., by control circuitry) such that the effect of deadtime on the applied bridge voltages is eliminated by achieving ZVS at the instant of toggling switches.

In some embodiments, control circuitry 112 may execute the method 800 by accessing at least some of equations (1)-(20) and equations (A1) and (A2), and by calculating the outputs of these equations. In some embodiments, control circuitry 112 may execute the method 800 by accessing values in memory 111 (or any component thereof) that may be used to apply or determine parameters values used in or calculated from equations (1)-(20). Control circuitry 112 may otherwise or additionally execute the method 800 by accessing values in memory 111 (or any component thereof) that may be used to retrieve or determine a control scheme (e.g., a switch toggling scheme, e.g., for the primary bridge of the DAB converter) that causes desired currents (e.g., for measuring values used in equations (1)-(20)) to flow through the transformer of the DAB converter.

Measurement design 810 may include control circuitry 112 configuring how to operate a DAB converter to determine the leakage inductance of a transformer of the DAB converter. Measurement design 810 may include causing a current to flow through a transformer of the DAB converter, which may include at least configuring parameters of the current (e.g., in advance of causing the current to flow).

At 811, control circuitry 112 chooses (e.g., determines, e.g., retrieves from memory and/or calculates) values of m_{ac} and ωᵢₙⱼ to satisfy equations (9)-(11). Based on 811, at 812, control circuitry 112 chooses Dₚ to satisfy equations (7)-(8). Based on 812, at 813, control circuitry 112 chooses m_{dc} to satisfy equations (14)-(16). It is noted that equations (1)-(6) may be used by control circuitry 112 within the operation at 811, 812, 813, or any combination thereof. It is noted that satisfying these equations may be based on properties (e.g., a transformer saturation current, a low-pass filter attenuation, a sampling rate, a SNR associated with a sensor, any other suitable property of PEM 105, or any combination thereof) of the DAB converter.

Measurement recording 820 may include control circuitry 112 measuring the current that is caused (e.g., in connection with measurement design 810, e.g., by control circuitry 112) to flow through the transformer of the DAB converter. For example, control circuitry 112 may cause the current to flow (e.g., as per the first scheme or the tank resistance estimation mode, or as per the second scheme or the leakage inductance estimation mode) and then measure the current.

At 821, which may precede 822, control circuitry 112 runs the DAB converter in the high-frequency (HF) link resistance estimation mode (e.g., a mode that may correspond to the first scheme or the tank resistance estimation mode). As indicated by the arrows of the flowchart 800, the operation at 821 may be based on the value chosen at 813. In some embodiments, the resistance estimation mode at 821 may include the current profiles of FIG. 5 and/or the signal processing flow of FIG. 7.

At 822, control circuitry 112 runs the DAB converter in the inductance estimation mode (e.g., a mode that may correspond to the second scheme or the leakage inductance estimation mode). As indicated by the arrows of the flowchart 800, the operation at 822 may be based on the value chosen at 812. In some embodiments, the inductance estimation mode at 822 may include the current profiles of FIG. 6 and/or the signal processing flow of FIG. 7.

Measurement evaluation 830 may include control circuitry 112 determining a leakage inductance of the transformer based on the measured current (e.g., as measured during measurement recording 820). Measurement evaluation 830 may include evaluating one or more of the current profiles shown in FIGS. 5 and 6 (e.g., to calculate the resistance and leakage inductance of the transformer).

At 831, control circuitry 112 may determine the measured current i_{t,rms}^{meas} (e.g., i_{t,rms}^{meas} 708, e.g., based on the signal processing approach as shown in FIG. 7) and apply this measured current to calculate a leakage resistance R_{lkg}^{est} (e.g., which may correspond to the tank resistance, e.g., Rₜ 312 or Rₑₛₜ) using equation (A1). At 832, control circuitry 112 may apply the leakage resistance R_{lkg}^{est} (as determined at 831) to evaluate equation (A2). At 833, control circuitry 112 may determine a leakage inductance L_{lkg}^{est} (e.g., which may correspond to the leakage inductance, e.g., Lₜ 314, or Lₑₛₜ) as being equal to the output calculated from equation (A2).

Power conversion 840 may include control circuitry 112 operating a DAB converter in one or more power conversion modes (e.g., to power the electric vehicle 332 load based on an input from source voltage 302). At 841, control circuitry 112 may determine a control scheme for operating the DAB converter based on the leakage inductance (e.g., based on L_{lkg}^{est}).

In some embodiments, determining the control scheme at 841 includes determining a ZVS scheme (e.g., a mapping of switch toggling times based on a range of possible transformer leakage inductance values) for the DAB converter. In some embodiments, the ZVS scheme at 841 differs from a nominal ZVS scheme that is based on a nominal leakage inductance of the transformer, and the scheme at 841 increases, compared to the nominal ZVS scheme, a power conversion efficiency of the DAB converter when the determined leakage inductance deviates from the nominal leakage inductance.

In some embodiments, determining the control scheme at 841 includes scheduling one or more controller gains of the DAB converter (e.g., a mapping of gains based on a range of possible transformer leakage inductance values) based on the determined leakage inductance. In some embodiments, the gain scheduling scheme at 841 differs from a nominal gain scheduling scheme that is based on a nominal leakage inductance of the transformer, and the scheme at 841 increases, compared to the nominal gain scheduling scheme, accuracies of the plurality of scheduled gains for improved transient response when the determined leakage inductance deviates from the nominal leakage inductance.

In some embodiments, determining the control scheme at 841 includes applying one of the one or more gains (e.g., selecting a cell, row, column, or subregion of the mapping) based on a property of a load (e.g., electric vehicle 108 or energy storage system 110) that receives power from the DAB converter. In some embodiments, the property of the load is an impedance (which may be a dynamic impedance that may be recorded in real-time). In some embodiments, the property of the load is a state of charge.

In some embodiments, determining the control scheme at 841 includes determining many control schemes, each one of the control schemes corresponding to a respective mode of operation of the DAB converter (e.g., one of the power modes of FIG. 4, or any other suitable power delivery mode of the DAB converter).

FIG. 9 is an illustrative circuit schematic of a second dual active bridge (DAB) converter, in accordance with some embodiments of the present disclosure. In some embodiments, second DAB converter 900 corresponds to first DAB converter 300. In some embodiments, all numbered elements of FIG. 9 leading with a “9” and ending with two digits correspond to respective numbered elements of FIG. 3 leading with a “3” and ending with the same two digits. It is noted that certain elements are added or omitted in FIG. 9, compared to FIG. 3, because certain elements are only used in methods described in connection with FIG. 9 or in methods described in connection with FIG. 3. It is noted that the inclusion or omission of such elements in only one DAB converter does not imply that these elements are present or absent from the other DAB converter.

As shown in FIG. 9, an output current (I₀) may be recorded (e.g., using current sensor 925) based on power that is delivered to a load (e.g., that is selectively connected to the DAB converter using relay 934). As also shown in FIG. 9, an output voltage (V₀) may be recorded (e.g., using voltage sensor 221) across capacitor 928, and this output voltage is coupled to the load when the relay 934 is closed. It is noted that electric vehicle load 332 may correspond to internal resistance 935 and battery voltage 936.

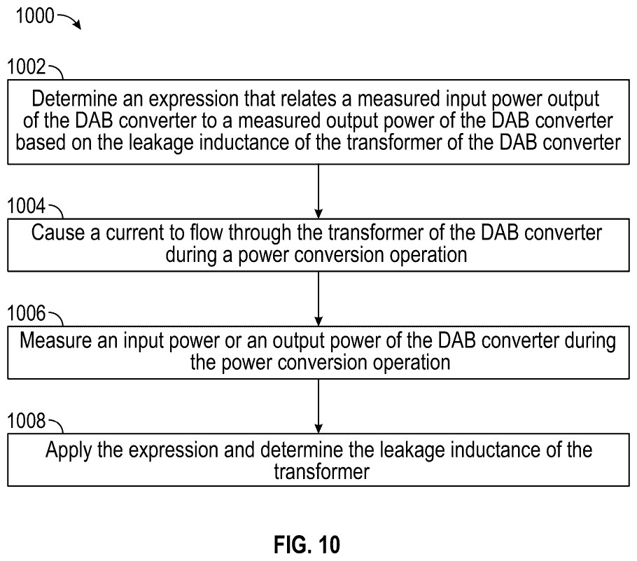

FIG. 10 is an illustrative flowchart of a second method (e.g., performed by control circuitry 112) for determining the leakage inductance of a DAB converter, in accordance with some embodiments of the present disclosure. In some embodiments, determining the leakage inductance of the transformer includes applying an expression that relates a measured input power of the DAB converter to a measured output power of the DAB converter when the current flows through the transformer of the DAB converter. In some embodiments, the second method 1000 (including the expression that is used at 1002) is executed with reference to the annotated elements and signals of FIG. 9.

At 1002, control circuitry 112 determines an expression that relates a measured input power output of the DAB converter to a measured output power of the DAB converter based on the leakage inductance of the transformer of the DAB converter. In some embodiments, the expression relates the input and output powers for a particular power conversion mode (e.g., one of the modes shown in FIG. 4, or any other suitable power conversion mode) of the DAB converter. For example, many possible expressions at 1002 may correspond to many possible operating conditions of the DAB converter, including operation in single phase shift (SPS), dual phase shift (DPS), triple phase shift (TPS), or extended phase shift (EPS) modes.

An illustrative expression (e.g., to be used in connection with 1002) is given in equation (21):

$${L}_{t} = \frac{{V}_{in}^{2}}{2 π {f}_{sw}^{*} {P}_{m e a s}} ( ϕ ) ( 1 - \frac{ϕ}{π} ) \frac{{V}_{o} N}{{V}_{in}} \qquad ( 21 )$$

where Lₜ is the DAB transformer leakage inductance, V_{.} is an output voltage (e.g., which is defined as indicated in FIG. 9), ϕ is a phase shift between primary bridge and secondary bridge voltages (e.g., voltages respectively occurring across windings 916 and 918), N is a turns ratio between the primary and secondary bridges (e.g., a turns ratio between windings 916 and 918), Pₘₑₐₛ is a measured input or output power (e.g., Vₒ*Iₒ or Vᵢₙ*Iᵢₙ) of the DAB converter, and f^{*}_{sw} is a switch toggling frequency (e.g., as is associated with at least one switch of the primary or secondary bridges of the DAB converter).

In some embodiments, solving equation (21) relies on measuring the terms of equation (21) through a duty cycle of the primary bridge and a duty cycle of the secondary bridge of the DAB converter. For example, solving equation (21) may include integrating power that is driven across one or more of the bridges of the DAB converter during one or more corresponding duty cycles.

It is noted that the method 1000 may be implemented with terms that can all be measured during a normal power conversion operation of a DAB converter. Therefore, control circuitry 112 may execute method 1000, dynamically determine a leakage inductance of the transformer of a DAB converter, and optionally modify a control scheme of the DAB converter based on the leakage inductance, all while simultaneously providing an output power.

At 1006, the control circuitry 112 measures an input power or an output power (or both) of the DAB converter during the power conversion operation. As described above, the input and/or output power may be used in connection with calculating the leakage inductance using equation (21).

At 1008, the control circuitry 112 applies the expression (e.g., equation (21)) and determines the leakage inductance of the transformer by evaluating the expression. In some embodiments, method 1000 also includes (e.g., in a process that may correspond to power conversion 840) the control circuitry 112 determining and implementing a control scheme of the DAB converter based on the leakage inductance.

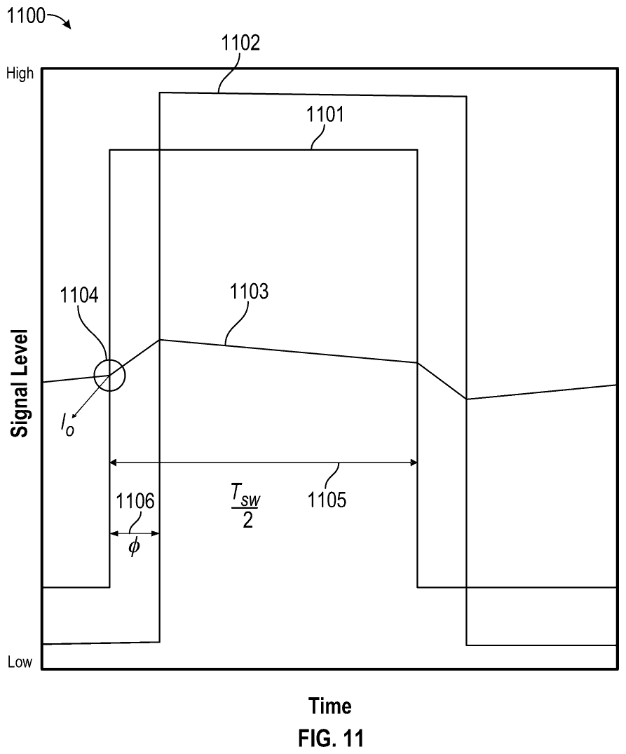

FIG. 11 is an illustrative depiction of DAB converter signals for determining the leakage inductance of the transformer of a DAB converter during a power conversion operation, in accordance with some embodiments of the present disclosure. FIG. 11 shows a primary bridge voltage 1101, a secondary bridge voltage 1102, and a transformer current 1103. In some embodiments, output current I₀ 1104 (e.g., as is used to determine Pₘₑₐₛ) is recorded at the illustrative moment in time 1104 (e.g., when the primary bridge voltage transitions from low to high). In some embodiments, as shown in FIG. 11, switching time T^{*}_{sw}/2 (e.g., half the reciprocal of f^{*}_{sw}) (e.g., as is used to determine Lₜ) is a time given by the time interval 1105 between the primary bridge voltage transitioning from low to high and the primary bridge voltage transitioning from low to high. In some embodiments, as shown in FIG. 11, phase shift ϕ (e.g., as is used to determine Lₜ) is a time given by the time interval 1106 between the primary bridge voltage transitioning from low to high and the primary bridge voltage transitioning from high to low.

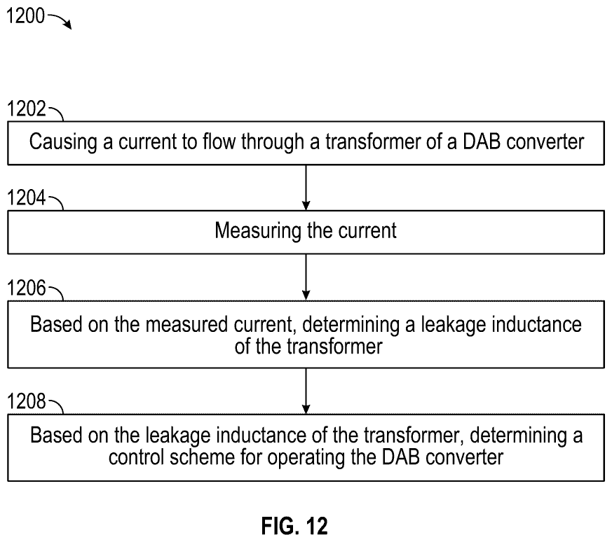

FIG. 12 is an illustrative flowchart of a method 1200 for determining a control scheme for operating a DAB converter based on a determined leakage inductance, in accordance with some embodiments of the present disclosure. In some embodiments, FIG. 12 is executed by control circuitry 112 (e.g., based on data stored in memory 111) to operate DAB converter 114.

At 1202, control circuitry 112 causes a current to flow through a transformer (e.g., transformer 218 or 317) or a DAB converter. In some embodiments, the operations at 1202 may correspond to measurement design 810 (e.g., to choose parameters of the current) and at least part of measurement recording 820 (e.g., causing the current to flow through the transformer may occur in HF link resistance estimation mode 821 and inductance estimation mode 822). In some embodiments, causing the current to flow may include causing the waveforms of FIGS. 5 and 6 to occur. In some embodiments, the operations at 1202 may correspond to the operations at 1004 (e.g., control circuitry 112 may execute method 1200 during a power conversion operation).

At 1204, control circuitry 112 measures the current (e.g., i_{t,rms}^{meas}). In some embodiments, measuring the current includes measuring one or both of the filtered transformer currents 530 and 630. In some embodiments, measuring the current includes implementing the signal processing flowchart of FIG. 7. In some embodiments, measuring the current includes recording the waveforms and/or parameters of FIG. 11 (e.g., at least recording time intervals 1105 and/or 1106). In some embodiments, the operations at 1204 may correspond to at least part of measurement recording 820 (e.g., measuring the currents that were caused to flow through the transformer may occur in HF link resistance estimation mode 821 and inductance estimation mode 822). In some embodiments, the operations at 1204 may correspond to at least part of the operations at 1006 (e.g., measuring an input power or an output power may include measuring the current).

At 1206, control circuitry 112 determines a leakage inductance (e.g., Lₑₛₜ or leakage inductance 314) of the transformer based on the measured current. In some embodiments, determining the leakage inductance includes applying equations (A1) and (A2), and at least part of equations (1)-(20). In some embodiments, the operations at 1206 may correspond to measurement evaluation 830 (e.g., the operations at 831, 832, and 833). In some embodiments, determining the leakage inductance is based on determining the leakage resistance (e.g., Rₑₛₜ). In some embodiments, the operations at 1206 may correspond to the operations at 1008.

At 1208, control circuitry 112 determines a control scheme for operating the DAB converter based on the leakage inductance of the transformer. In some embodiments, the operations at 1208 may correspond to power conversion 840 (e.g., the operations at 841). In some embodiments, the control scheme includes at least one of a gain scheduling or a ZVS scheme. In some embodiments, the control scheme is based on (e.g., modified with respect to) a nominal control scheme, where the nominal control scheme is based on a nominal leakage inductance and the amount of modification between the control scheme and the nominal control scheme is based on a deviation between the determined leakage inductance at 1206 and the nominal leakage inductance.

Thus it has been shown that systems and methods for determining the leakage inductance of a transformer of a DAB converter, and for operating the DAB converter based on the determined leakage inductance, have been provided.

It is noted that the control circuitry 112 may cause a current with a DC offset (e.g., as in equations (1)-(20)) to flow across a bridge of the DAB converter and may cause the toggling of the switches of the bridge under non-ZVS conditions (e.g., in the tank resistance estimation mode). The corresponding losses occurring across one or more of these switches may be evaluated by control circuitry 112 to calculate the DC voltage across the transformer (e.g., in equations (12) and (A1)).

It is noted that the control circuitry 112 may cause a sinusoidal current to flow across the transformer with a frequency that does not saturate the transformer. However, low frequencies may introduce SNR limitations or other challenges in calculating the magnitude of the applied voltage. Therefore, the control circuitry 112 may introduce a specific phase shift (e.g., between first and second triangular carrier waveforms, as mentioned above) that achieve ZVS switching (e.g., when operating in the leakage inductance estimation mode) while driving a sufficiently small current amplitude to prevent peaking currents from flowing across the transformer (e.g., because such peaks may saturate the transformer).

The processes described above are intended to be illustrative and not limiting. One skilled in the art would appreciate that the steps of the processes described herein may be omitted, modified, combined and/or rearranged, and any additional steps may be performed without departing from the scope of the invention.

The foregoing is merely illustrative of the principles of this disclosure, and various modifications may be made by those skilled in the art without departing from the scope of this disclosure. The above-described embodiments are presented for purposes of illustration and not of limitation. The present disclosure also can take many forms other than those explicitly described herein. Accordingly, it is emphasized that this disclosure is not limited to the explicitly disclosed methods, systems, and apparatuses, but is intended to include variations thereto and modifications thereof, which are within the spirit of the following claims.

What is claimed is:

1. A method for operating a dual active bridge (DAB) converter comprising:
causing a current to flow through a transformer of the DAB converter;
measuring the current;
based on the measured current, determining a leakage inductance of the transformer; and
based on the leakage inductance of the transformer, determining a control scheme for operating the DAB converter.

2. The method of claim 1, wherein:
determining the control scheme comprises determining a zero-voltage switching scheme for the DAB converter; and
the control scheme:
differs from a nominal control scheme based on a nominal leakage inductance of the transformer; and
increases, compared to the nominal control scheme, a power conversion efficiency of the DAB converter when the determined leakage inductance deviates from the nominal leakage inductance.

3. The method of claim 1, wherein:
determining the control scheme comprises scheduling a plurality of gains of the DAB converter based on the determined leakage inductance; and
the control scheme:
differs from a nominal control scheme based on a nominal leakage inductance of the transformer; and
increases, compared to the nominal control scheme, accuracies of the plurality of scheduled gains when the determined leakage inductance deviates from the nominal leakage inductance.

4. The method of claim 3, further comprising:
applying one of the plurality of gains based on a property of a load that receives power from the DAB converter.

5. The method of claim 1, wherein determining the control scheme comprises determining a plurality of control schemes, each one of the plurality of control schemes corresponding to a respective mode of operation of the DAB converter.

6. The method of claim 1, wherein determining the leakage inductance of the transformer comprises, based on the measured current:
determining a tank resistance of the transformer; and
determining the leakage inductance based on the tank resistance.

7. The method of claim 6, wherein:
the measured current comprises a first measured waveform and a second measured waveform;
the first measured waveform is used to determine the tank resistance; and
the second measured waveform is used to determine the leakage inductance.

8. The method of claim 7, wherein causing the current to flow through the transformer of the DAB converter comprises:
controlling a first leg of a bridge of the DAB converter based on a first triangular carrier waveform and a first DC modulation signal;
controlling a second leg of the bridge of the DAB converter based on a second triangular carrier waveform and a second DC modulation signal; and
configuring a phase shift between the first triangular carrier waveform and the second triangular carrier waveform such that an amplitude of the current through the transformer is within a predetermined current range when toggling switches of the first leg and switches of the second leg.

9. The method of claim 8, further comprising:
configuring the first DC modulation signal and the second DC modulation signal such that a deadtime of the first leg and a deadtime of the second leg are within a predetermined range.

10. The method of claim 7, wherein causing the current to flow through the transformer of the DAB converter comprises:
controlling a first leg of a bridge of the DAB converter based on a first triangular carrier waveform and a first sinusoidal modulation signal;
controlling a second leg of the bridge of the DAB converter based on a second triangular carrier waveform and a second sinusoidal modulation signal; and
configuring a frequency of the first triangular current waveform and a frequency of the second triangular current waveform such that a frequency of the current through the transformer is within a predetermined range.

11. The method of claim 10, further comprising:
configuring the first sinusoidal modulation signal and the second sinusoidal modulation signal such that an amplitude of the current through the transformer is within a predetermined range.

12. The method of claim 10, further comprising:
configuring a phase shift between the first triangular current waveform and the second triangular current waveform such that an amplitude of the current through the transformer is within a predetermined current range when toggling switches of the first leg and switches of the second leg.

13. The method of claim 1, further comprising configuring a secondary side bridge of the DAB converter such that, while causing the current to flow through the transformer of the DAB converter, a voltage across the secondary side bridge is equal to zero.

14. The method of claim 1, wherein measuring the current comprises:
low-pass filtering the current; and
determining a root mean square value of the filtered current.

15. The method of claim 1, wherein determining the leakage inductance of the transformer comprises applying an expression that relates a measured input power of the DAB converter to a measured output power of the DAB converter when the current flows through the transformer of the DAB converter.

16. A dual active bridge (DAB) converter comprising processing circuitry configured to:
cause a current to flow through a transformer of the DAB converter;
measure the current;
based on the measured current, determine a leakage inductance of the transformer; and
based on the leakage inductance of the transformer, determine a control scheme for operating the DAB converter.

17. The DAB converter of claim 16, wherein the processing circuitry is configured to determine the control scheme for operating the DAB converter by determining a zero-voltage switching scheme for the DAB converter, wherein the control scheme:
differs from a nominal control scheme based on a nominal leakage inductance of the transformer; and
increases, compared to the nominal control scheme, a power conversion efficiency of the DAB converter when the determined leakage inductance deviates from the nominal leakage inductance.

18. The DAB converter of claim 16, wherein the processing circuitry is configured to determine the control scheme for operating the DAB converter by scheduling a plurality of gains of the DAB converter based on the determined leakage inductance, wherein the control scheme:
differs from a nominal control scheme based on a nominal leakage inductance of the transformer; and
increases, compared to the nominal control scheme, accuracies of the plurality of scheduled gains when the determined leakage inductance deviates from the nominal leakage inductance.

19. The DAB converter of claim 17, wherein the processing circuitry is configured to determine the leakage inductance of the transformer by, based on the measured current:
determining a tank resistance of the transformer; and
determining the leakage inductance based on the tank resistance.

20. A non-transitory computer-readable medium having non-transitory computer-readable instructions encoded thereon that, when executed by a processor, cause the processor to:
cause a current to flow through a transformer of a dual active bridge (DAB) converter;
measure the current;
based on the measured current, determine a leakage inductance of the transformer; and
based on the leakage inductance of the transformer, determine a control scheme for operating the DAB converter.
